(19) United States
(12) Patent Application Publication
(10) Pub. No.: US 2005/0229220 A1
(43) Pub. Date: Oct. 13, 2005

(54) System and method for interactive video services

(76) Inventors: William Fisher, Coconut Grove, FL (US); Jonathan Towers, Glencoe, IL (US)

Correspondence Address: FAY KAPLUN & MARCIN, LLP, 15O BROADWAY, SUITE 702, NEW YORK, NY, 10038, US

(21) Appl. No.: 10/818,963

(22) Filed: Apr. 6, 2004

(51) Int. Cl. H04N 7/173; H04N 7/16

(52) U.S. Cl. 725/89; 725/94

(57) ABSTRACT

A method, comprising the steps of storing a full-length video program, storing a short form program, wherein the short form program is an edited version of the full-length video program, storing searchable parameters for the full-length video program and the short form program, receiving a search request from a user, the search request including search parameters and returning search results to the user including the full-length video program and the short form program when the search parameters match the searchable parameters of the full-length video program and the short form program.

### BACKGROUND INFORMATION

In most developed countries, almost every home has a television. The programming choices available to television consumers has increased dramatically over the past 25 years with the proliferation of cable television (“CATV”) and, more recently, satellite television services. Other sources of video programming are also available to modern consumers such as streaming Internet video. The CATV, satellite and broadband services also allow consumers access to video on demand (“VOD”) services. The VOD services offered by these providers may include such services as programs, games and movies on demand.

### SUMMARY OF THE INVENTION

A method, comprising the steps of storing a full-length video program, storing a short form program, wherein the short form program is an edited version of the full-length video program, storing searchable parameters for the full-length video program and the short form program, receiving a search request from a user, the search request including search parameters and returning search results to the user including the full-length video program and the short form program when the search parameters match the searchable parameters of the full-length video program and the short form program.

Furthermore, a system, comprising a receiving module configured to receive full-length video programming content from a programmer, an editorial module configured to edit the full-length video programming content into short form content and a storage module configured to store the full-length video content and the short form content. The system further includes a categorization module configured to store information on the full-length video content and short form content, a search module configured to receive search parameters from a user and search the stored information and a display module configured to send search results to the users based on the search parameters.

In addition, a platform system, comprising an aggregation module to collect a plurality of full-length video programs from programmers, an editorial module to edit the full-length video programs to meet requirements to distribute the full-length video programs on-demand and to edit the full-length video programs to create independent short form programs corresponding to the full-length video programs, an advertising module to receive advertising content from advertisers, wherein the advertisers pay a fee to include the advertising content in the platform system and a consumer module to provide consumer services to users of the platform.

Also, a method, comprising the steps of providing on-demand full-length video programming content to a user for a fee and providing on-demand short form programming content to the user at no cost, the short form content being an edited version of the full-length video programming content, wherein the short form content is provided with advertising content.

A method, comprising the steps of providing a linear channel network to a consumer, the linear network channel being video-on-demand portal enabled, providing an video-on-demand portal to the consumer, the consumer accessing the video-on-demand portal by one of directly accessing the video-on-demand portal and accessing the video-on-demand portal via the linear channel network, wherein, when the video-on-demand portal is accessed via the linear channel network, the consumer is displayed a branded video-on-demand portal related to the linear channel network and providing video-on-demand portal applications to the consumer, wherein the video-on-demand portal applications include one of a search portal application, a purchase content application, a access free content application and an access commercial content application;

A system, comprising a server including stored video content, categorization information for the stored video content and video-on-demand portal information. The system further including a set top box configured to tune to a linear network channel and further configured to tune to an video-on-demand portal channel, the video-on-demand portal channel including access to a main video-on-demand portal and a customized portal corresponding to the linear network channel, wherein the set top box tunes from the linear network channel to the video-on-demand portal channel and receives a portion of the video-on-demand portal information to display the customized portal on a display screen connected to the set top box, the customized portal display including information for the consumer to search the stored video content based on the categorization information and purchase the stored video content.

### BRIEF DESCRIPTION OF DRAWINGS

FIG. 1 shows an exemplary schematic diagram of the relationship between the EOD Video Services Platform and the constituents served by the EOD Video Services Platform according to an exemplary embodiment of the present invention;

FIG. 2 shows exemplary categories of features and/or services provided by the EOD Video Services Platform including consumer services, editorial services, search and marketplace services and platform services according to the present invention;

FIG. 3 shows an exemplary process for a consumer to access the EOD Video Services Platform according to the present invention;

FIG. 4 shows a portion of an exemplary channel line-up from an operator offering the EOD Video Services Platform according to the present invention;

FIG. 5 shows an exemplary schematic showing a system which includes the EOD Video Services Platform and various constituents according to the present invention;

FIG. 6 shows an exemplary portal entry screen (“Back Door” entry) of an EOD-enabled linear network channel portal according to the present invention;

FIG. 7 shows an exemplary search result display screen of an EOD-enabled linear network channel portal according to the present invention;

FIG. 8 shows an exemplary sponsor referral screen of an EOD-enabled linear network channel portal according to the present invention;

FIG. 9 shows an exemplary category screen of an EOD-enabled linear network channel portal according to the present invention;

FIG. 10 shows an exemplary topic screen of an EOD-enabled linear network channel portal according to the present invention;

FIG. 11 shows an exemplary sub-topic screen of an EOD-enabled linear network channel portal according to the present invention;

FIG. 12 shows an exemplary Front Door or main display screen of the EOD Video Services Platform according to the present invention; and

FIG. 13 shows an exemplary Front Door or main topic screen of the EOD Video Services Platform according to the present invention.

### DETAILED DESCRIPTION

The present invention may be further understood with reference to the following description and the appended drawings, wherein like elements are provided with the same reference numerals. The present invention includes a system and method for providing a single comprehensive resource for authoring, distributing and managing all on-demand content offered by the service provider, e.g., CATV provider, satellite provider, Internet Service Provider (“ISP”), etc. Throughout this description, this system and method will be referred to as Everything-on-Demand (“EOD”) or the EOD Video Services Platform. The EOD Video Services Platform includes all the features of VOD as currently deployed, but further includes additional functions, features and support services (e.g., editorial services, aggregation services, search services, navigation services, etc) which allows EOD to function as a single, stand-alone authoring, distribution and management resource for the deployment of on-demand content with respect to consumers, advertisers, content providers and system operators. These features will be described in greater detail below.

Traditional television networks provide viewers with linear programming, i.e., programs are presented in a predetermined time sequence and run the length of their given time slot, with or without commercial interruption, with the viewer having no control over the selection, sequence or run-time. VOD provides viewers the choice of viewing programming in a non-linear fashion, i.e., the viewer selects the program from a menu provided by the operator and at a time of the viewer's preference to watch the selected program. VOD may also provide additional features to the viewer of a program such as the ability to rewind, fast forward, pause, etc.

The EOD Video Services Platform and its operator offer all the features of VOD services as currently deployed, but with additional features which make the EOD Video Services Platform unique and a substantial enhancement of traditional VOD service. An EOD Video Services Platform operator offers a complex platform of resources and services. The EOD Video Services Platform includes a combination of multiple components that function together in a unique manner in the service of presenting consumers, advertisers, content providers and system operators with a single solution for the authoring, distribution and management of on-demand video content. The components include source programming resources (e.g., long-form programs), editorial services (e.g., post-production/editing services), short-form programming resources (e.g., results of the editorial services), advertising content (e.g., video, banner ads, etc.), navigational resources (search engine, unique user interface, etc.), storage resources, set-top box applications, systems interface (e.g., billing systems, middleware, etc.), etc.

Additional details of these components will be described below including examples of the deployment and/or use of these components within the EOD Video Services Platform. The components of the EOD Video Services Platform may be configured in multiple manners. In addition, the components of the EOD Video Services Platform may be implemented or deployed modularly in order to accommodate the needs of each programmer, operator, advertiser and consumer.

The EOD Video Services Platform is an aggregator and editor of 3rd party content. The EOD Video Services Platform operator will license programming from multiple sources (e.g., broadcast networks, cable networks, independent producers, rights-holders, etc.) and deploy the programming in its integral original form (i.e., full-length). In addition, the EOD Video Services Platform operator will provide editorial services to create short form content from this licensed source material, i.e., the EOD Video Services Platform operator itself will edit the source material to produce abbreviated programming.

Furthermore, the EOD Video Services Platform operator will act as an advertising intermediary by selling sponsorship opportunities, direct sales links and commercial spot placement to advertisers. Examples of advertising opportunities include banner ads to inform EOD users of advertisers' products and services, hyperlinks to allow EOD users to port from the EOD Video Services Platform to advertisers and retailers' Web sites for transactions, the insertion (by EOD) of advertiser's commercial spots into the VOD programming stream, etc.

The EOD Video Services Platform operator and operators who deploy the EOD Video Services Platform will generate multiple revenue streams based on the unique approach to monetizing programming provided by the EOD Video Services Platform. Examples of revenue streams based on the EOD Video Services Platform include the display and insertion of paid advertising messages in on-demand programming, transactional one-off consumer purchases of long-form programming on a pay-per-use basis, long-term (e.g., monthly) subscriptions, etc. The EOD Video Services Platform allows operators to adopt these revenue models on a modular basis to fit the circumstances or business model requirements of each individual operator.

he EOD Video Services Platform is a turnkey solution for the operators because it provides the operators (e.g., cable and broadband operators) with a single end-to-end solution for deploying, managing and monetizing on-demand programming assets, complete with all content and enabling technology required for distribution. As will be described in more detail below, if an operator decides to deploy the EOD Video Services Platform, the operator simply needs to provide the EOD Video Services Platform operator with minimal access to a single digital channel and the entire EOD Video Services Platform can be deployed in the operator's system with minimal configuration and/or customization requirements. The EOD Video Services Platform operator will provide all the services and applications needed for full deployment within the operator's system. Also, as described above, the operator may select individual modular components of the EOD Video Services Platform to be deployed within its system.

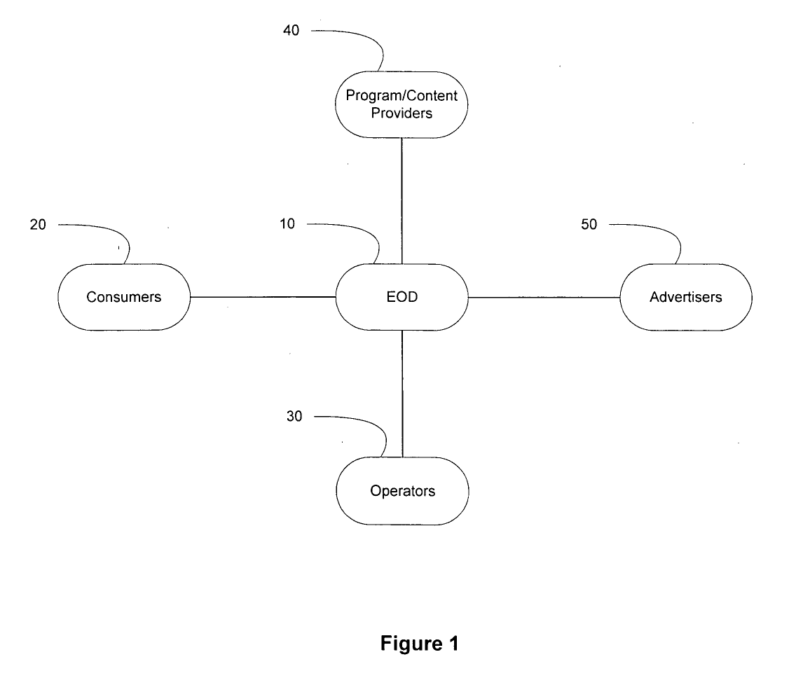

FIG. 1 shows an exemplary schematic diagram of the relationship between the EOD Video Services Platform 10 and the constituents 20-50 served by the EOD Video Services Platform 10. Each of the constituents 20-50 will be described, but it should be noted that the descriptions are only exemplary and that the constituents may change based on the particular EOD Video Services Platform 10 implemented for a particular service. In addition, any particular EOD Video Services Platform 10 may support more or less constituents than the exemplary constituents described herein.

The first described constituent is the programmers/content providers 40 (referred throughout as programmers 40). The programmers 40 are generally the source of most programming shown on television. The programmers may be the traditional broadcast networks such as ABC, NBC, CBS, etc., cable networks such as A&E, MTV, Biography Channel, History Channel, etc, pay television or subscription supported networks such as HBO, Showtime, etc., or any other programmers which provide content to viewers. The programmers 40 may be the original producer of the content or it may purchase the content from a third party production company. For the purposes of this description, it may be considered that the programmers 40 are the source of the content irrespective of whether the programmer is the original producer of the content material. Furthermore, throughout this description, the terms “networks,” “channels” and their variants will be used to describe these sources of programming.

The operators 30 are the entities which distribute the programming provided by the programmers 40. In the case where the operator 30 is a CATV system operators, the distribution system may be a proprietary system which includes switching stations, optical and coaxial cable runs, etc., serving individual retail subscribers or consumers. In the exemplary case where the operator 30 is a satellite service, the distribution system includes one or more satellites which beam the signals to consumer reception dishes. In a further exemplary case where the operator 30 is an ISP, the distribution system may be a communications system such as the public Internet or a private communication system. Those of skill in the art will understand that there may be any number of other systems which can be used by the operators 30 to distribute the programming provided by the programmers 40. Throughout this description, the term “system” and its variants will be used to describe the distribution medium for the content.

The third constituent is the advertisers 50 which pay to insert ads or commercials into the content produced by the programmers 40 and delivered by the operators 30. The final constituent is the consumers 20 which are the viewers of the shows. The content is delivered by the operators 30 into the home of the consumers 20 which the consumer may then view on their television sets, computer screens, etc.

The following is a short description of a traditional relationship of these constituents 20-50 without the EOD Video Services Platform 10 interposed between the constituents. In a traditional relationship, the programmer 40 delivers the content to the operator 30. A first set of advertisers 50 may pay the programmer 40 to include ads in the content provided by the programmer 40. The operator 30 also pays the programmer 40 for the delivery of the content. Thus, the programmer 40 may derive revenue from two sources, the advertisers 50 and the operator 30. A second set of advertisers 50 may pay additional money to the operator 30 to insert additional ads in the provided content before it is delivered to the consumers 20. The operator 30 then makes the content available to those consumers 20 which have subscribed to the operator's 30 service. Thus, the operator 30 may also derive revenue from two sources, the advertisers 50 and the consumers 20. The advertisers 50 accomplish their goal of reaching consumers 20 and the consumers 20 view the content provided on their televisions. Those of skill in the art will understand that the preceding description is only exemplary and that there are numerous variations of these relationships. For example, when the programmer 40 is a traditional broadcast network, the operators 30 may not pay any fee for the content provided by these traditional broadcast networks.

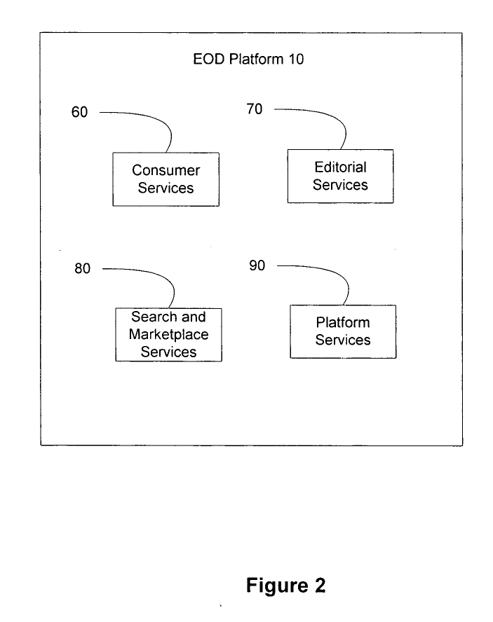

The EOD Video Services Platform 10 of the present invention is interposed between these constituents 20-50 and allows for a novel relationship to be forged between the constituents 20-50. FIG. 2 shows general categories of features and/or services provided by the EOD Video Services Platform 10 including consumer services 60, editorial services 70, search and marketplace services 80 and platform services 90. These features and services allow the EOD Video Services Platform 10 to be an upgrade from traditional VOD services. Each of these services 60-90 will be described in greater detail below including examples. An exemplary EOD Video Services Platform 10 may implement one or more of these services 60-90.

The consumer services 60 offered by an exemplary EOD Video Services Platform 10 may include personalized user interfaces, search functions, navigation functions, e-commerce referrals, free on-demand delivery of short form programming and long-form infomercial and fee-based premium services (including long-form programming) from multiple programming sources. The editorial services 70 offered by an exemplary EOD Video Services Platform 10 may include the editing of source material from the programmers 40 to create new programming assets (e.g., the short form programming) and the configuration of linear programs for on-demand use.

The search and marketplace services 80 offered by an exemplary EOD Video Services Platform 10 manage and monetize the suite of services offered by the EOD Video Services Platform 10. The search and marketplace services 80 enable the consumers 20 to find and access programming and services, point consumers 20 to ancillary information, provide consumers 20 with the opportunity to purchase products and services related to programming they have viewed and allow advertisers 50 to match commercial messages and appropriate audiences with great precision and receive exact viewing data. The platform services 90 enable operators 30 to offer a turnkey platform for VOD services through the addition of the EOD Video Services Platform 10 to the digital tier off programming.

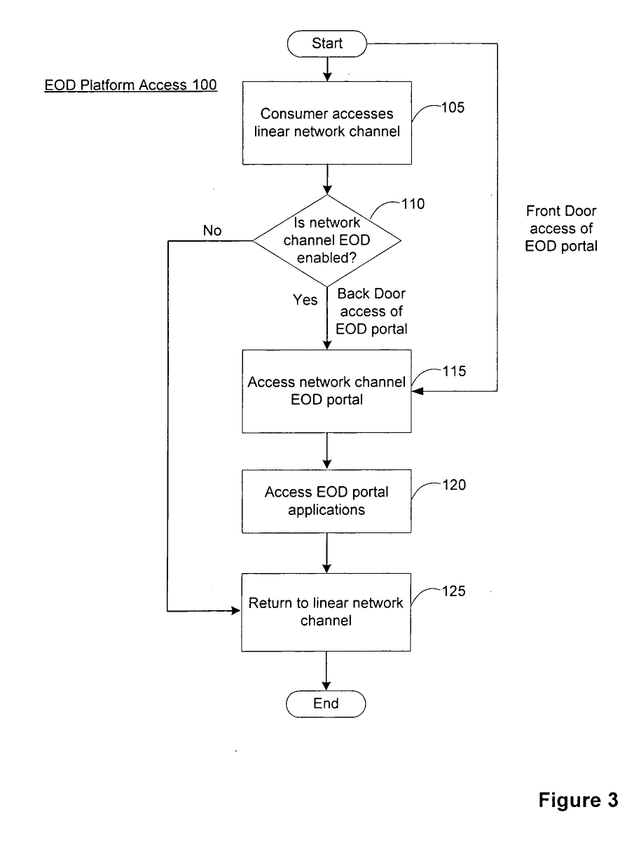

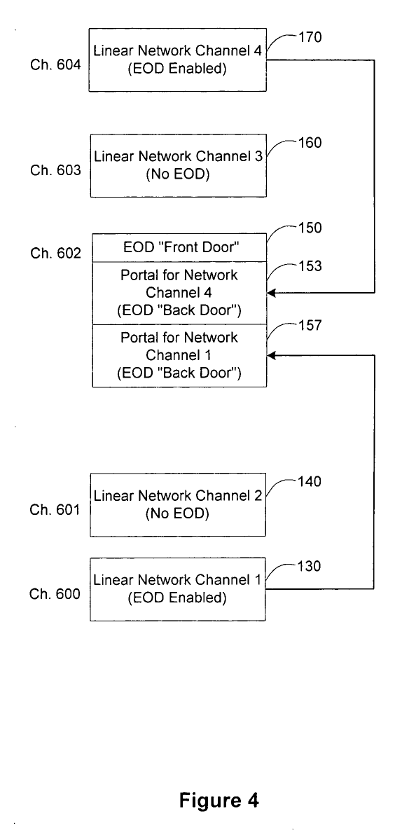

FIG. 3 shows an exemplary process 100 for a consumer 20 to access an EOD Video Services Platform 10. The process of FIG. 3 will be described with reference to FIG. 4 which shows a portion of an exemplary channel line-up from an operator 30 offering an EOD Video Services Platform 10. The channel line-up shows five exemplary channels. Channel 600 having Network Channel 1 (130) which is EOD-enabled. Channel 601 having Network Channel 2 (140) which is not EOD-enabled. Channel 602 which is the channel 150 reserved for the EOD Video Services Platform 10. Channel 603 having Network Channel 3 (160) which is not EOD-enabled and channel 604 having Network Channel 4 (170) which is EOD-enabled. The network channels may include any of the programmers 40 linear networks, e.g., History Channel, Biography Channel, etc.

Referring back to FIG. 3, the consumer 20 accesses any of the network channels 130, 140, 160 and 170 offered by the operator 30 in step 105 or may proceed directly to step 115 to access the EOD Video Services Platform. When the consumer 20 directly accesses the EOD Video Services Platform 10 at step 115, this access of the EOD Video Services Platform 10 is referred to as “Front Door” access. When the consumer 20 accesses the EOD Video Services Platform via the linear network channels (as will be described below with reference to steps 110 and 115), this access of the EOD Video Services Platform 10 is referred to as “Back Door” access. The concepts of Front Door access and Back Door access will be described in greater detail below.

When the consumer 20 decides to first access the linear network channels 130, 140, 160 and 170 (step 105), this is performed in the normal manner that a consumer would tune to a network channel, e.g., after the television is turned on, a remote control may be used to tune to the desired channel, for example, channel 600 which is Network Channel 1 (130). In a preferred embodiment, the operator 30 offers a digital television service. The digital television service is accessed by the consumer 20 via a set top box which may include a remote control to control the operation of the set top box. A portion of the EOD Video Services Platform 10 services and applications may also be contained in the set top box, thereby allowing these applications to be accessed by the consumer via the remote control.

As shown in FIG. 4, some of the network channels (Network Channel 1 (130) and Network Channel 4 (170)) are enhanced by proprietary EOD applications (“EOD-enabled”), while other network channels (Network Channel 2 (140) and Network Channel 3 (160)) are not EOD-enabled. If the network channel is EOD-enabled, the EOD Video Services Platform 10 applications in the set top box may be triggered when the consumer selects a graphic element or icon embedded in the linear network channel signal via the set top box with the remote control. For example, if a consumer tuned to channel 600 which is the EOD-enabled Network Channel 1 (130), the EOD applications in the set top box may be triggered, thereby allowing the consumer to enter the EOD Video Services Platform 10, which as will be described below is presented as EOD channel 602 (150). An EOD application on the set top box may determine if the linear network channel is EOD-enabled based on the video stream that is flowing through the set top box.

The fact that a particular channel is EOD-enabled may be signaled to the consumer 20 by providing an icon or graphic on the television screen when the linear network channel is displayed. The consumer may access the EOD Video Services Platform 10 by selecting the icon or graphic element and pressing a button on the remote control when there is an indication that the linear network channel is EOD-enabled. In an alternative embodiment, there may be no display, but the button on the remote control may not be active unless the linear network channel is EOD-enabled. Those of skill in the art will understand that there may be multiple means of triggering redirection or re-tuning from linear network channel to the EOD Video Services Platform 10.

Referring back to FIG. 3, a consumer 20 may desire to access the EOD Video Services Platform 10 for the linear network channel to which the consumer 20 is currently tuned. In step 110, it is determined whether the linear network channel to which the consumer 20 is tuned is EOD-enabled. If the channel is not EOD-enabled the process 100 continues to step 125 which returns the consumer 20 to the linear network channel which the consumer 20 was watching. For example, if the consumer is tuned to channel 601 Network Channel 2 (140) which is not EOD-enabled, and the consumer 20 attempts to access the EOD Video Services Platform 10, the attempt will fail and return the consumer 20 back to the linear channel 601 Network Channel 2 (140) because it is not EOD-enabled.

If the linear network channel is EOD-enabled, the process will continue to step 115 where the consumer 20 will access the customized linear network portal on the EOD Video Services Platform 10. For example, if the consumer was tuned to channel 600 Network Channel 1 (130) which is EOD-enabled, and the consumer 20 attempts to access the EOD Video Services Platform 10, the consumer 20 will be sent to the portal 157 for Network Channel 1 (130). Similarly, if the consumer was tuned to channel 604 Network Channel 4 (170) which is EOD-enabled, and the consumer 20 attempts to access the EOD Video Services Platform 10, the consumer 20 will be sent to the portal 153 for Network Channel 4 (170). The portals for the linear network channels will be described in greater detail below.

As shown in FIG. 4, the customized linear network portals 153 and 157 are located within, or as a subset of, EOD channel 602 (150). Thus, the consumer 20 who was tuned to channel 600 Network Channel 1 (130) is directed via the EOD applications on the set top box to EOD channel 602 (150) for access to the portal 157. Thus, the operator 30 in order to provide the EOD Video Services Platform 10 to its consumers 20, may make one channel (e.g., EOD channel 602 (150)) available for the EOD Video Services Platform 10. Multiple portals for EOD-enabled linear networks may be presented on the one channel, e.g., EOD channel 602 (150). The system and method for making these portals available will be described in detail below.

Once the consumer 20 has accessed the EOD Video Services Platform 10, the consumer 20 may then access the portal applications available for the particular EOD-enabled linear network which the consumer has selected (step 120). Each portal may have various applications which the consumer may select for use, e.g., search library functions, purchase full length programs, access free short form programming, access commercial content, link to retailers, etc. As will be described in greater detail below, each of the programmers 40 which have an EOD-enabled linear network may have a unique portal configuration to display the supported applications in the portal. For example portal 153 for linear Network Channel 4 (170) may have a completely different look and feel from portal 157 for linear Network Channel 1 (130). In addition, the supported applications may be different for each of the portals 153 and 157. Moreover, the portals 153 and 157 support preferences and may be configured by the consumer 20 to best suit that consumer's needs. When the consumer is finished accessing the EOD Video Services Platform 10, the consumer may exit the EOD Video Services Platform 10 and return to the original linear network channel to which the consumer was tuned (step 125).

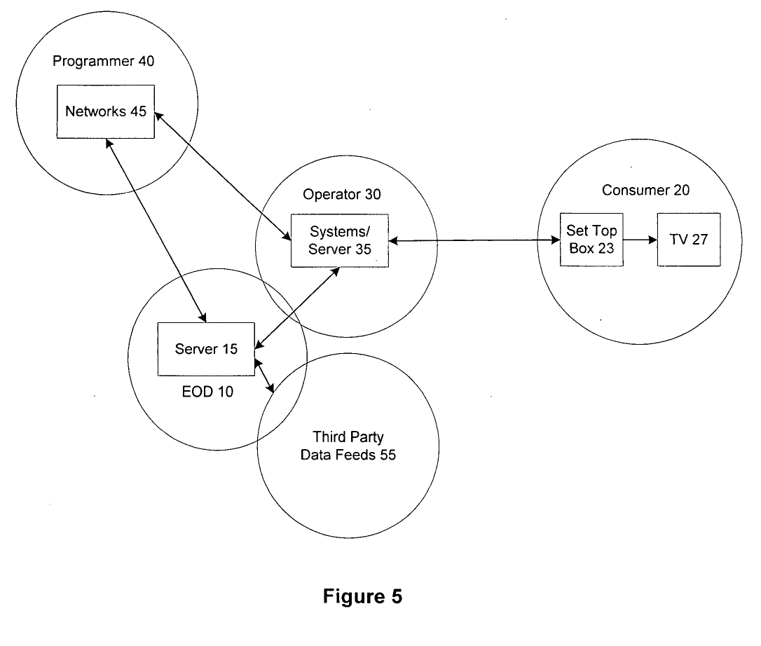

FIG. 5 shows an exemplary schematic showing a system which includes the EOD Video Services Platform 10 and the various constituents 20-50. In this exemplary system the programmer 40 has programming networks 45 (e.g., networks, channels or programs) which operate in a manner well known in the art to provide the linear programming content to the operator 30. Similarly, the operator 30 has operator systems 35 which operate in a manner well known in the art to receive the linear programming content from the programmer 40 and distribute the linear programming content to the consumer 20 which receives the linear programming content through the set top box 23 and displays it on television 27. Those of skill in the art will understand that this is merely one exemplary manner of providing linear programming and that the present invention may be used to enhance any other methods by which linear programming is provided to consumers 20.

In the exemplary system of FIG. 5, this normal linear programming is enhanced using the EOD Video Services Platform 10. The EOD Video Services Platform 10 is shown as a separate entity including server 15. However, the EOD Video Services Platform 10 may have additional components that are intermingled or distributed throughout the other entities. These additional components may be hardware or software components. For example, as described above, there may be EOD applications included on the set top box 23 for the consumer 20 to access the EOD Video Services Platform 10.

In addition, the server 15 is shown as a single component for the purposes of illustration. However, the server 15 of the EOD Video Services Platform 10 may include multiple hardware and software resources to accomplish the described functions of the EOD Video Services Platform 10. For example, on the hardware side, the server 15 may include one or more computing devices having processors to run applications, memory systems (e.g., random access memory (“RAM”), permanent memory to store the content, etc.), communications devices, input/output devices, etc. On the software side, the server 15 may include Web server applications, search engine applications, database applications, etc. Thus, the server 15 of the EOD Video Services Platform 10 will include multiple hardware and software components to accomplish the described functionality of the EOD Video Services Platform 10.

Furthermore, as shown in FIG. 5, there may be overlap between the systems 35 of the operator 30 and the server 15 of the EOD Video Services Platform 10 and between the third party data feeds 55 and the server 15 of the EOD Video Services Platform 10. Thus, the server 15 may be considered to be a distributed system where hardware and software is physically and virtually housed in multiple locations. An example of distributed hardware that may be included as part of server 15 is a server or an electronic storage facility (or multiples of these hardware components) for storing full-length video content that is physically housed by the operator 30. Such servers or storage facilities are considered to be part of the server 15 of the EOD Video Services Platform 10 even though they are not physically located in the facility of the EOD Video Services Platform operator because they are part of the system allowing the EOD Video Services Platform 10 to deliver the content and services to consumers 20. Similarly, there may be servers (or other hardware devices) at third party sites which store, for example, Web sites or Internet destinations to which the EOD Video Services Platform 10 will direct the consumers 20. In the same manner as described above, these hardware components located at the third party sites are also included as part of the server 15 of the EOD Video Services Platform 10 because they are part of the system allowing the EOD Video Services Platform 10 to deliver the content and services to consumers.

Thus, throughout this description, whenever the term “server 15” is used, it should be understood that this may refer to any of the distributed components (hardware and/or software) of the EOD Video Services Platform 10 irrespective of the location of those components. Moreover, any individual component may be part of both the systems 35 of the operator 30 and the server 15 of the EOD Video Services Platform 10 (or the third party data feeds 55 and the server 15). As described above, the servers located at the operator 30 facility which may store full-length video content may be considered as both part of the server 15 of the EOD Video Services Platform 10 and the systems 35 of the operator 30.

As shown in FIG. 5, the server 15 of the EOD Video Services Platform 10 communicates with the networks 45 of the programmer 40. This communication may be used to receive the content produced by the programmer 40. For example, as described above, the EOD Video Services Platform 10 may make full length programs produced by the programmer 40 available to the consumer 20 in a non-linear fashion. To accomplish this feature, the EOD Video Services Platform 10 must have access to the those programs which the programmer 40 desires to make available on a non-linear basis to the consumer 20. This access may be provided in a variety of manners. For example, the programmer 40 may send the programs directly to the EOD Video Services Platform 10 where the EOD Video Services Platform will save the programs for later distribution when a consumer 20 requests the program. The programs may be sent indirectly through the EOD Video Services Platform 10 to the operator 30 and then be stored on the operator's systems 35 or they may be stored at the server 15. It will be the choice of the programmer 40 as to which of its programs it will make available to the EOD Video Services Platform 10. The programmer 40 may make its entire catalogue of programs available or some subset of its catalogue.

In addition, the EOD Video Services Platform 10 manages the programming assets of the programmer 40 that may have been provided to the EOD Video Services Platform 10 so that these programming assets are made available to the consumer 20. As will be described in greater detail below this management allows a consumer 20 to access the programming content in a simple and intuitive manner, thereby increasing the probability that a consumer 20 will pay for access to the content and that advertisers 50 will pay for delivery of advertising content via the EOD Video Services Platform 10. The EOD Video Services Platform 10 enhances the value of the linear network channel of the programmer because it appears to the consumer 20 that the network has provided the on-demand capability. Thus, a consumer 20 who is familiar with the content of a particular linear channel network may feel comfortable purchasing content associated with the programmer 40. This consumer 20 purchase of content provides a new source of revenue to the programmer 40.

The communication between the systems 35 of the operator 30 and the server 15 of the EOD Video Services Platform 10 will occur at many different levels. In a first instance, the communication may be for the same reason as described above for the programmer 40, e.g., the operator 30 may have content which it desires to make available through the EOD Video Services Platform 10. In another instance, when the consumer 20 accesses the EOD Video Services Platform 10 via the set top box 23, the applications on the set top box 23 are establishing a two way communication between the EOD Video Services Platform 10 and the set top box 23 (which by extension is the consumer 20). In particular, the set top box 23 is establishing communications with the operator systems 35 allowing communications with the server 15 of the EOD Video Services Platform 10, whether the EOD server 15 component is distributed within the systems 35 of the operator or within the EOD Video Services Platform operator location.

As described above, a consumer 20 may access the EOD Video Services Platform 10 by using the remote control to port from a linear network channel which is EOD-enabled (e.g., Network Channel 1 (130)) to the EOD channel (150). Thus, the operator 30 has set aside a channel (e.g., channel 602) for this communication between the consumer 20 and the EOD Video Services Platform 10. When the application on the set top box 23 has ported the consumer 20 to the EOD channel 150, another application module on the set top box 23 initiates a browser application in order to load the desired portal for the consumer 20. The browser application communicates the portal request to the EOD Video Services Platform 10 including the parameters of the request. These parameters may include the linear network channel from which the consumer 20 made the request to access the EOD Video Services Platform 10 (e.g., Network Channel 1 (130)), the local address of the set top box 23 of the consumer 20, etc.

This communication from the browser application on the set top box 23 is communicated via the channel dedicated to the EOD Video Services Platform 10 (e.g., channel 602) to the systems 35 of the operator 30. The request is then directed to the server 15 of the EOD Video Services Platform 10 and is processed by a Web server application on the server 15. The Web server application retrieves the requested portal based on the parameters in the request. The server 15 may contain any number of portals for the EOD-enabled linear network channels. It may be considered that the portals are analogous to a set of Web pages for each of the EOD-enabled linear network channels. Those of skill in the art will understand that the portals may include screens for which the displayed content is predetermined or screens where the displayed content is based on the particular parameters contained in the request, e.g., the displayed content on a portal search result screen will depend on the search parameters requested by the user and the displayed content is gathered on an ad hoc basis based on these search parameters. Additionally, with respect to advertising content, as will be described in greater detail below, the advertising content may be presented on a display screen based on the particular parameters associated with the content to be displayed.

The server 15 may contain multiple portals for each of the EOD-enabled linear network channels. The server 15 will direct the consumer to the correct portal screen based on the parameters in the request. Each individual portal may be simultaneously served (at the same or different locations within the portal) to multiple consumers 20. The server 15 then directs, based on the location parameters in the request, the data for the requested portal back through the systems 35 to the set top box 23 where it is configured by the browser application for viewing on the television 27. Thus, the systems 35 of the operator 30 provide a transport system for the communications between the EOD applications on the set top box 23 and the server 15.

In addition to the arrangements described above, the server 15 of the EOD Video Services Platform 10 may also receive information from third party data feeds 55. These data feeds may include data from a variety of sources that relate to the services provided by the EOD Video Services Platform 10. For example, a third party data feed 55 may be a data feed from advertisers 50 who are providing commercial video content, ad content, special offer content, links for purchases, etc. The example of links for purchases illustrate that the communication between the server 15 and the third party data feed 55 may be two-way communication. For example, one of the advertisers may be a Web based retailer such as Amazon.com. The EOD Video Services Platform 10 as part of its marketplace services 80 may provide the consumer with the ability to link through to the Web retailer. An example of such a link will be described in greater detail below.

It should be noted that the terms Web server and Web browser as used in this description may apply to both commercially available Web servers and browsers or proprietary Web servers or browsers. The term Web server is used to denote a server process running on the EOD Video Services Platform 10 which directs consumers to portals in response to requests from remote browsers. The term Web browser is used to denote a remote program used to view, download, upload, interact with or otherwise access portals stored on the EOD Video Services Platform. Browsers read portal pages that are “marked up” or coded. The browser interprets the code into what a consumer sees rendered on the television 27.

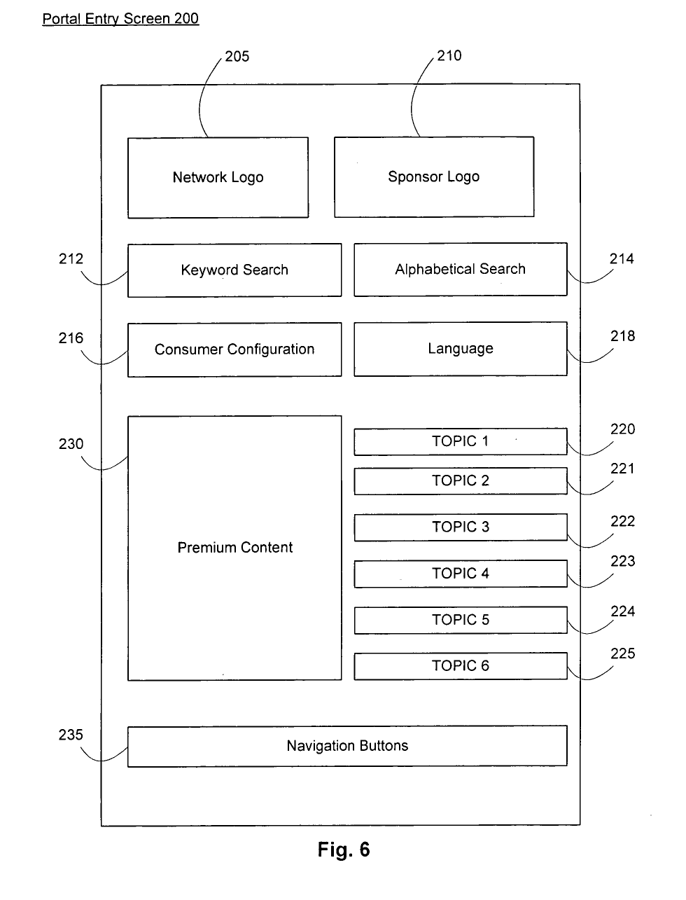

The following describes an exemplary consumer session using the EOD Video Services Platform 10. FIGS. 6-11 will be used to describe the exemplary session. For the purposes of describing this exemplary session, it will be assumed that the consumer 20 is viewing an EOD-enabled linear network channel, e.g., Network Channel 1 (130). Further, in this exemplary session, this network channel is the Biography Channel. Thus, the Biography Channel has made available all or a portion of its programming material for access through the EOD Video Services Platform 10.

The consumer 20 is viewing the EOD-enabled Biography Channel and uses the remote control to access the EOD Video Services Platform 10 via the set top box 23. The EOD applications on the set top box 23 transport the consumer 20 to the EOD channel 150 and activates the browser application in the set top box 23, which initiates a request for the Biography Channel portal to the server 15. The Web server application on the server 15 processes the request, redirects the consumer to the Biography Channel portal data and sends this data back to the set top box 23 of the consumer 20. The browser application formats the data and displays the Biography Channel portal on the television 27.

FIG. 6 shows an exemplary portal entry screen 200 for a network channel portal. As part of the services provided by the EOD Video Services Platform 10, the portal entry screen 200 is designed to appear to the consumer 20 as an extension of the linear network channel, i.e., the portal entry screen 200 has the “look and feel” of the linear network source channel. Thus, the screen 200 includes a network logo 205 which may be the name and/or logo of the linear network channel which is EOD-enabled. In our example, the network logo 205 would be the logo of the Biography Channel allowing the consumer 20 to be aware of which network's portal they have entered. The Biography Channel co-logos the portal to simulate the “look and feel” of the corresponding linear network logo.

The screen 200 also includes a sponsor logo 210 which is a name and/or logo to indicate the primary paid sponsor for the portal. For example, an automobile company may be a primary sponsor 210 of the network channel portal. This is an example of how the EOD Video Services Platform 10 allows targeted advertising for various sponsors. For example, a beer company may desire to sponsor a sports channel's portal, a financial services company may desire to sponsor a financial channel's portal, etc. The advertiser 50 can target their sponsorship to desired demographics based on such a primary sponsorship scheme. Using the remote control buttons, the consumer may, at any time, select the sponsor logo 210 and the Web browser application will retrieve information from the server 15 showing the latest products, services or special offers from the sponsor.

This also illustrates additional information which may be stored on server 15 of the EOD Video Services Platform 10. The advertisers 50 may send offer details to the server 15 to update the various sponsorships of the network channel portals. As described above, the server 15 components may be distributed at various locations, thus, the server 15 component which stores commercial content may be systems of the advertisers, electronic retailers, etc., which may be retrieved by the EOD Video Services Platform. These offers may be updated periodically (e.g., monthly, weekly, daily). Thus, the EOD Video Services Platform 10 opens up a new advertising revenue stream for the EOD Video Services Platform 10 operator, the programmer 40 and the operator 30 along with a new targeted advertising opportunity for the advertisers 50. While a programmer 40 may have an independent Web site which includes sponsorship, such a Web site does not have the functionality associated with the EOD Video Services Platform 10 in its ability to deliver video content to the consumer 20. Similarly, the operator 30 may offer VOD service as currently deployed, but such a service does not offer the preference configurations, navigational and portal schemes for addressing consumer requests nor does it allow for access to the same video content or the advanced search features associated with the EOD Video Services Platform 10. By offering such services, the EOD Video Services Platform 10 offers a new form of advertising revenue by matching consumers with appropriate commercial content.

The display screen 200 also includes a keyword search button 212 and alphabetical search button 214. The buttons 212 and 214 may be used to search for video content and other features within the portal. An example of a search using one of these buttons will be provided below. The display screen 200 further includes a consumer preference configuration button 216. This button 216 may allow the consumer to set certain preference configuration parameters for the network channel portal. Examples of configuration choices may include language preference selection, closed captioning on video display, etc. Another example of a configuration may be to allow the consumer 20 to enter personal information such as a credit card number so that when the consumer 20 makes a purchase through the portal the credit card information has been previously stored for the consumer 20. These configuration choices are communicated to the server 20 and saved for each individual consumer 20 so that each time the consumer 20 accesses the particular portal, the portal will operate in the manner desired by the consumer 20. The EOD Video Services Platform 10 may also have an option of saving default configuration selections for all the available portals so that the consumer 20 does not need to individually configure preferences for each portal. The language button 218 allows the consumer 20 to select the language both of the portal and of the video which may be selected and played via the portal.

The display screen 200 further includes topic buttons 220-225 which may be configured for the individual portal. In the example of the Biography Channel, the topic buttons may include topics such as Crime, Hollywood, History, International, News, Politics, Sports, etc. These topic buttons allow for an easy starting point for thematic searches by the consumer 20. The premium content field 230 is an area where the portal will display a set of premium (or “for pay”) choices for a particular time period (e.g. monthly). In the example of the Biography Channel, there may be three new biographies which were produced and offered for the first time to the consumers 20. The Biography Channel may desire to highlight these biographies because their subjects may currently be in the news. Thus, the linear network channel may select the premium content 230 it desires to highlight or promote on the screen 200. The bottom of the display screen 200 may contain various navigation buttons 235 which instruct the consumer on how to move about the display screen 200 or access different displays of the portal.

Those of skill in the art will understand that the display screen 200 is only exemplary and that there may be numerous manners of presenting the exemplary information that was described with respect to display screen 200. For example, a different linear network channel may present information in a different manner based on the particular content which the linear channel desires to make available to the consumer 20. However, it should be noted that while there may be numerous manners of presenting the information, the object of presenting exemplary information in FIG. 6 is to illustrate the features and functionality of the EOD Video Services Platform 10. For example, as described in detail above, the sponsor logo 210 illustrates how the EOD Video Services Platform 10 allows for additional advertising revenue and targeted marketing. The network logo information 205 illustrates how the EOD Video Services Platform 10 allows individual linear network channel programmers to customize the appearance and content which the channel is making available.

Another example is the search information (e.g., keyword search button 212, alphabetical search button 214 and topic search buttons 220-225) which illustrates that the EOD Video Services Platform 10 allows consumers various methods of searching for the content they desire and that the EOD Video Services Platform allows operators 30, programmers 40 and advertisers 50 to push particular content to the consumers 20.

The exemplary session will continue with an exemplary description of a consumer search. In this example, the consumer 20 desires to make an alphabetical search. Thus, the consumer 20 will use the remote control to highlight and enter the alphabetical search button 214. The Web browser application on the set top box 23 will indicate the consumer's 20 selection to the server 15 which will retrieve the appropriate portal search screen and send the data back to the set top box 23 to display the search screen on the television 27.

The search screen for an alphabetical search may be, for example, a simulated keyboard displayed on the television 27. The consumer 20 may use the remote control to select the appropriate letter for the desired search. For example, the consumer 20 may desire to find content related to the movie “The Godfather.” In such a case, the consumer 20 will highlight the letter “G” on the screen. Depending on the amount of content available under the letter “G” additional search screens may appear to the consumer 20. For example, if there is a multitude of content available under the letter “G”, a further search screen may display subcategory buttons with alphabetical ranges such as “GA-GEM,” “GEN-GIP,” etc. The consumer 20 may select the appropriate alphabetical button for “Godfather” (e.g., “GOD-GOL”) and a further search screen showing each of the available categories under this alphabetical range may be displayed. These categories may be displayed as selectable buttons which the consumer 20 may select. The display may include a scroll feature when all the available category buttons cannot be displayed on a single screen.

Prior to continuing with the exemplary consumer session, it should be noted that the above described search is conducted using a search engine application included in the server 15 of the EOD Video Services Platform 10. As described in detail above, the programmers 40 will make content available through the EOD Video Services Platform 10. However, in order for the content to be searchable by a consumer 20, the content needs to be categorized for the purposes of searching. Any entity may provide this categorization, but it is anticipated that the operator of the EOD Video Services Platform 10 will be the primary source for these categorization services (e.g., metadata creation and encoding) as a subset of the search services 80 offered by the EOD Video Services Platform 10.

The categories will correspond to the various manners of searching. For example, as described above, an alphabetical search may be performed. Thus, the EOD Video Services Platform 10 will contain an alphabetical listing of all the available content from the programmer 40 for the EOD-enabled network channel. Similarly, screen 200 shows a keyword search button 212. Thus, the EOD Video Services Platform 10 will contain keywords associated with all of the available content. Each of the content material may include multiple keywords for the purposes of searching. Also, as shown on screen 200, the content material may be searched based on a general theme as shown by the topic buttons 220-225. Thus, each of the content material may have one-or more themes associated with the content. For example, content on Ronald Reagan may be themed under both Hollywood and Politics.

Those of skill in the art will understand that there are numerous manners of saving this categorization information for the purposes of allowing a search engine to search the data. For example, each piece of content material may have a database record associated with the material. The database record will store, e.g., the title for alphabetical searching, keywords for keyword searching, etc. The search engine will search the database based on the criteria selected by the consumer 20 and return the results. Another example of a searchable storage technique is to store a Web page for each piece of content material, the Web page having a series of metadata associated with it, whereby the search engine searches for hits based on the metadata. These are only two examples of storage and search methods that may be implemented by the EOD Video Services Platform 10 and many others may also be implemented.

In addition to storing data on the content material for searching purposes, the EOD Video Services Platform 10 will also store other information on the content material. This other information may include the physical storage location of the content material so that the EOD Video Services Platform 10 may retrieve and send the content to a consumer 20, the length of the content material, a rating of the content material, a review of the content material, etc. A further example of other information may include links to material related to the content. For example, as described above, the EOD Video Services Platform 10 may have both full length content material and short form material. As will be described below, the short form material may be derived from the full length material. Thus, each of the entries for the full length material and the short form material may include links which relate the two pieces of material or any other material which it is deemed should be related.

Another example of stored information for the purposes of linking material is the storage of advertiser 50 data. This data may include any type of advertisement content, e.g., video ad content, banner ads, shopping links, etc. In addition to the storage of this data, the EOD Video Services Platform 10 will store information which links the advertisement messages to the particular programming content with which it is to be delivered within the EOD Video Services Platform 10. For example, the sponsor logo or banner ad 210 includes information that this sponsor logo or banner ad 210 should be included when display screen 200 is shown to the consumer 20. However, there may be other types of information stored about the ad content so that it is displayed at the appropriate time or on the appropriate screen to the consumer 20. For example, some ads may be pushed to the consumer 20 based on the particular search that the consumer performs, some ads may be pushed to the consumer based on the length of time that the consumer 20 has spent in the portal, etc. Those of skill in the art will understand that there are any number of manners of targeting ads to a consumer 20 based on the consumer's actions. Some of these manners may include simple or complicated algorithms to determine the demographic of the consumer 20. In addition, the EOD Video Services Platform 10 may store information on the consumer 20 (e.g., past purchases, past searches, etc.) which more specifically focus the targeted advertising to the consumer 20. Several other examples of targeted advertising will be described below. Thus, the search engine of the EOD Video Services Platform 10, in addition to searching for video content contained on the EOD Video Services Platform 10, may also search for ad content which should be pushed to the consumer 20 based on the search or the progression of the consumer 20 through the portal.

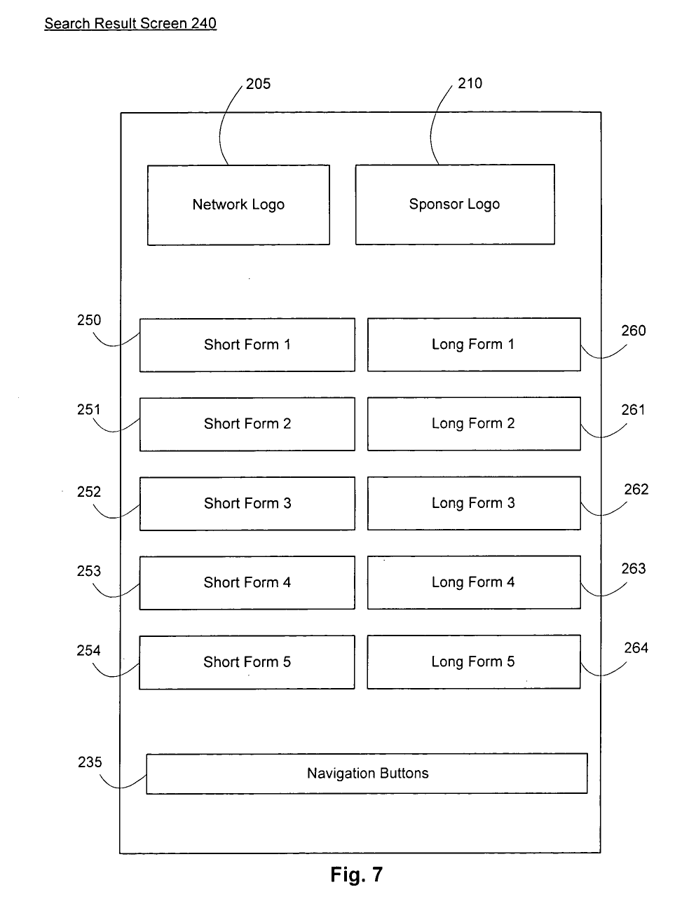

Continuing with the example started above, the consumer 20 has selected “Godfather” from the search screen. FIG. 7 shows an exemplary search result display screen 240 which the EOD Video Services Platform 10 displays the consumer 20. As with screen 200, the screen 240 includes the network logo 205, the sponsor logo 210 and the navigation buttons 235. Thus, each of the different pages of the portal appear to be consistent to the consumer 20. In this manner, the consumer 20 will understand that he is remaining in the portal for the selected network channel, e.g., the Biography Channel.

The screen 240 also displays various content associated with the search ( e.g., Godfather) that the consumer 20 may view. In this example, two types of content are displayed, short form content as displayed by buttons 250-254 and full-length video content as displayed by buttons 260-264. In the example of the search for Godfather, the search engine of the EOD Video Services Platform 10 may display titles such as “Marlon Brando,” “James Caan,” “Francis Ford Coppola,” “Mario Puzo,” etc., in the short form buttons 250-254 corresponding to available short form programming. Similarly, the full-length video buttons 260-264 may display titles such as “Francis Ford Coppola,” “Mario Puzo,” “Al Capone,” “Gambino Crime Family,” etc., corresponding to long-form programming (e.g., 30 minutes, 60 minutes, 90 minutes). The full-length video buttons 260-264 may also display additional information such as running time, etc.

As described above, the EOD Video Services Platform 10 also provides editorial services 70 to programmers 40 who provide content to the EOD Video Services Platform 10. These editorial services 70 may include the editing of full-length video content down to short form content (e.g., 3-5 minutes) which may be used as free or “advertising supported” preview material within the portal. For example, the short form Mario Puzo content may be an edited version of the full-length video full length biography show of Mario Puzo. The consumer 20 may decide to view the free short form content to determine whether they have an interest in paying for and watching the full length biography of Mario Puzo.

The order of the presented content may also be determined based on input from the advertisers 50. For example, an advertiser 50 may be a retailer of DVDs. The advertiser 50 may be running a special offer on Francis Ford Coppola DVDs. Thus, the advertiser 50 may pay to place Francis Ford Coppola on the first short form button, i.e., short form 1 button 250, or the first full-length video button, i.e., full-length video 1 button 260. If the consumer 20 decides to watch the Francis Ford Coppola content, a sponsor referral screen may show the special offers at the end of the viewing. The sponsor referral screen will be described in detail below. The button (e.g., buttons 250 and 260) may also include a link for the consumer 20 to view the special offer without viewing the content. This is another example of a new source of VOD-derived advertiser revenue and of targeted advertising for the advertisers 50.

In this example, the consumer 20 may select to watch the free short form content for Mario Puzo. The consumer will select the short form button associated with Mario Puzo, e.g., short form 5 button 254. The set top box 23 will format a request to be sent to the server 15. The request may include the requested content, the address of the set top box 23 making the request, etc. The request will be transmitted from the set top box 23 through the systems 35 of the operator 30 and will be received at the server 15 of the EOD Video Services Platform 10. The server 15 will process the request by retrieving the requested content from within the EOD Video Services Platform 10, formatting it for transmission and sending the content back through the system 35 to the set top box 23. The free short form content will be displayed to the consumer 20 on the television 27.

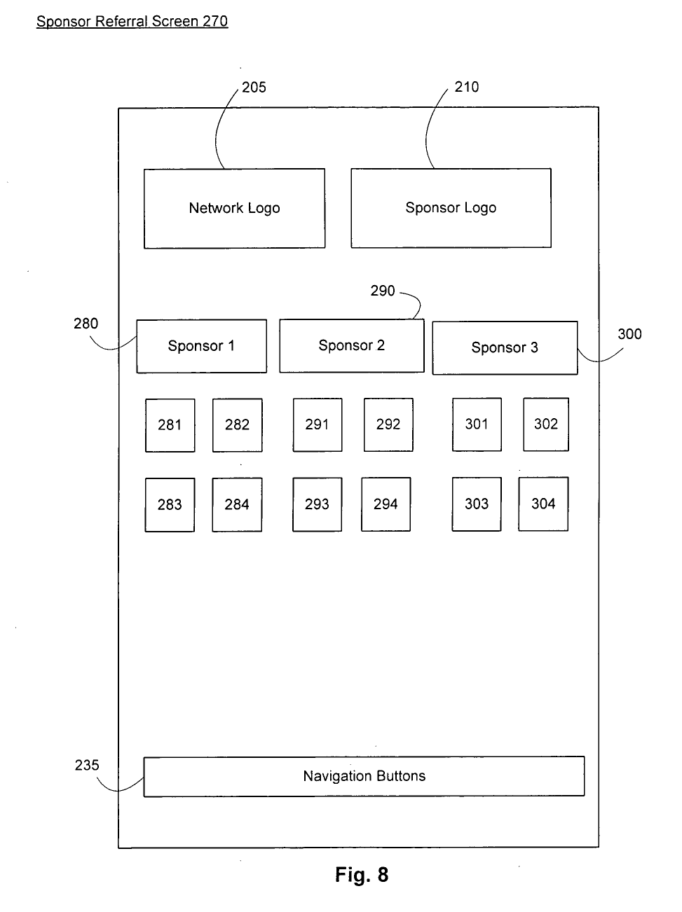

FIG. 8 shows an exemplary sponsor referral screen 270 which may be displayed after the conclusion of the free short form content selected by the consumer 20. Once again, the network logo 205, the sponsor logo 210 and the navigation buttons 235 will be displayed. In addition, additional sponsor buttons will be displayed, e.g., sponsor 1 button 280, sponsor 2 button 290 and sponsor 3 button 300. The ads for these sponsors may also include reference to specific products (e.g., products 281-284 for sponsor 1, products 291-294 for sponsor 2 and products 301-304 for sponsor 3) associated with the topic that are for sale by the sponsor. Again, for this example, sponsor 1 button 280 may be associated with a sponsor which sells books because Mario Puzo was an author. The products 281-284 may be books written by Mario Puzo. The sponsor 2 button 290 may be associated with a DVD retailer because Mario Puzo's books were made into movies. The products 291-294 may be DVDs based on Mario Puzo's books.

Once again the screen 270 shows several features of the EOD Video Services Platform 10. The network logo 205 shows how a network channel can build strong logo recognition within its own portal by being associated with every screen within the portal. Similarly, the sponsor logo 210 may be associated with every screen within the portal allowing for the maximum exposure of the logo to the target consumers 20 that enter the portal. The sponsor buttons 280, 290 and 300 illustrate how additional sponsors can target a consumer 20 based upon the specific actions of the consumer 20 within the portal. As described above, the sponsors 280, 290 and 300 may have information stored with their ad content indicating when the particular content should be displayed to the consumer 20. The search engine of the EOD Video Services Platform 10 will query for these particular parameters and display the ad content consistent with the parameters desired by the advertisers 50.

Finally, it also shows how a consumer 20 may interact with the portal to make purchases based on the advertisements which are pushed to the consumer 20. For example, the consumer 20 may determine that they want to buy the product 281 from the sponsor 280. The EOD Video Services Platform 10 allows the consumer 20 to select either the sponsor 1 button 280 or the specific product button 281. By selecting the appropriate buttons, the consumer 20 may display a purchase screen that allows them to purchase the product they desire. The purchase screen may be a port to the sponsor's Web page or some other type of order screen which allows the consumer 20 to place an order for the desired product. As described above, the server 15 of the EOD Video Services Platform 10 may have a communication link with third party data feeds 55. These third party data feeds 55 may be, for example, a link through the public Internet or a “walled garden” Web environment to an advertiser's 50 Website. This link allows the consumer 20 to make purchases at the advertiser's 50 Web site via the EOD Video Services Platform 10. In the case where the product cannot be purchased via the purchase screen, e.g., a car, the screen may provide information on where to purchase the product, special offers, etc.

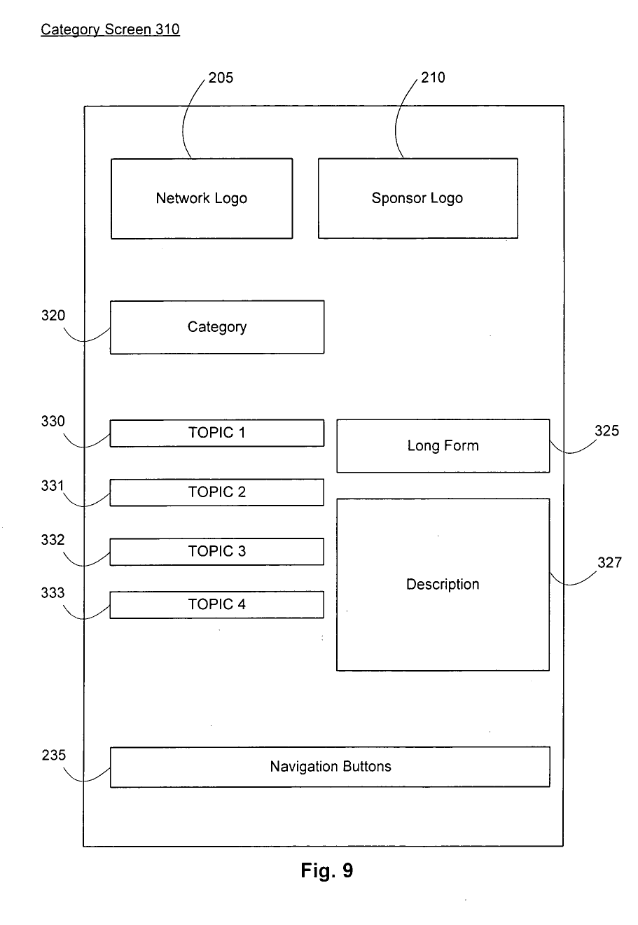

FIG. 9 shows an exemplary category screen 310 which the consumer 20 may enter after the sponsor referral screen 270 of FIG. 8. For example, the consumer 20 may or may not have made a purchase based on the sponsor offerings on the sponsor referral screen 270. The consumer 20 may then have used the navigation buttons 235 to arrive at the category screen 310 which is related to the topic of the short form video which the consumer 20 watched. As with the previous display screens, display screen 310 includes network logo 205, sponsor logo 210 and navigation buttons 235. The category screen also includes the category 320 to which the screen is related. In our example, the category is Mario Puzo because that was the short form video topic which the consumer 20 watched.

The display screen 310 may include a full-length video button 325 which is the button for the consumer 20 to select the full-length video content of the category 320, e.g., the full-length video biography of Mario Puzo. The screen 310 may also include a short text description 327 of the full-length video content. In addition, the screen 310 includes topic buttons 330-333 which relate to the general themes of the category 320. For example, the topic buttons 330-333 under the category 320 of Mario Puzo may be Bestsellers, Crime, Hollywood, Italy, New York, etc. These topic buttons 330-333 are additional search buttons which can be used by the consumer 20 to find related content in the same manner as the topic buttons 220-225 on screen 200.

As described for each of the screens previously, these described screens are only exemplary and the format in which the information is presented on various screens may be affected by numerous factors, e.g., the specific network channel portal, the type of content, the number of sponsors, the type of sponsors, etc. For example, the exemplary formats shown for the described screens may be an optimal format for a portal such as the Biography Channel. However, a sports channel such as ESPN may have a different optimal screen format. Further, the screen progressions described herein are only exemplary. There will be other ways to progress through the screens. For example, if the consumer 20 did an alphabetical search for Mario Puzo, the category screen 310 may be the first screen which is displayed to the consumer 20.

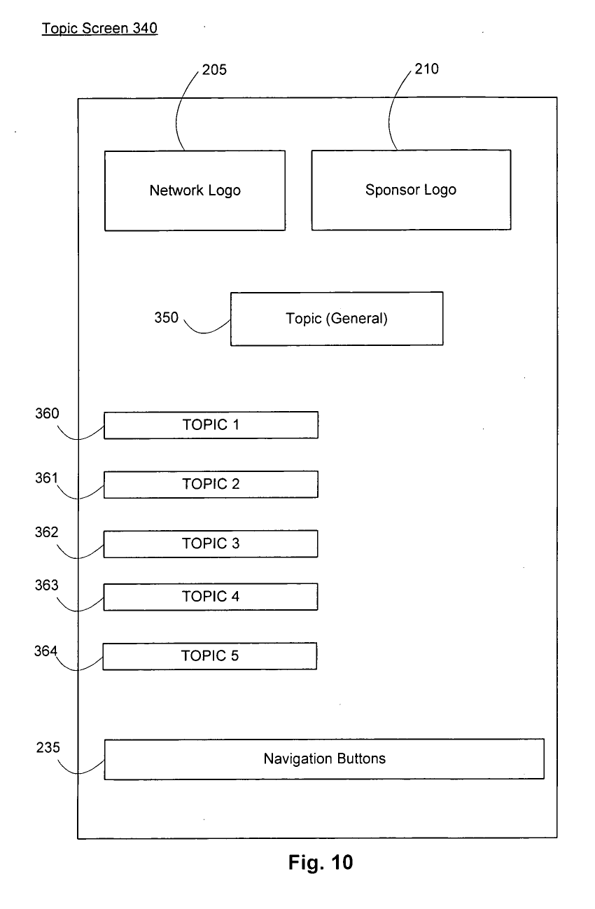

FIG. 10 shows an exemplary topic screen 340 that may be displayed when the consumer selects one of the topic buttons 330-333 of screen 310. The topic screen 340 includes network logo 205, sponsor logo 210 and navigation buttons 235. It further includes an indication of the general topic 350 and sub-topics 360-364 under the general topic 350. For example, if a consumer 20 on the category screen 310 having a category of Mario Puzo selected a topic button of Italy, the topic screen 340 will display the general topic 350 of Italy. The sub-topics 360-364 may include such topics as Arts, Fashion, Food, Literature, History, etc.

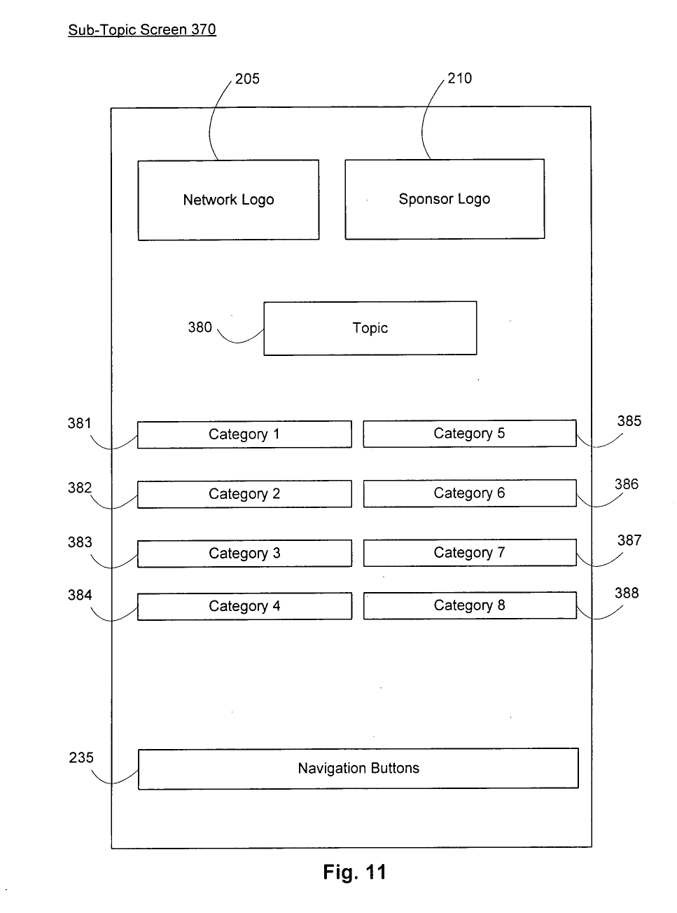

FIG. 11 shows an exemplary sub-topic screen 370 which may be displayed when a consumer selects one of the sub-topic buttons 360-364 of topic screen 340. The sub-topic screen 370 includes network logo 205, sponsor logo 210 and navigation buttons 235. It further includes an indication of the sub-topic 380 and categories 381-388 under the sub-topic 380. For example, if a consumer 20 on the topic screen 340 having a topic Italy selected a sub-topic button of Fashion, the topic screen 340 will display the sub-topic 380 of Italian Fashion. The categories 381-388 may include a list of categories under Italian fashions such as Giorgio Armani, Gianni Versace, etc. The categories 381-388 may again be sponsor pushed to the top of the list as described above.

Those of skill in the art will understand that a consumer 20 may continue to work their way through a variety of content by moving from screen to screen and through different topics, sub-topics and categories. At some point, the consumer 20 may decide to purchase full-length content for viewing. Continuing with the example above, the consumer 20 may desire to purchase the full length biography of Gianni Versace. The consumer 20 will select the appropriate button from a screen displaying the full length content video. The request will be forwarded to the server 15. Since this is a purchase of video content by the consumer 20, the consumer may navigate through several additional screens to inform the consumer 20 of the price and to verify that the consumer 20 desires to purchase the video content. When such verification has taken place, the server 15 will send the video content to the set top box 23 for display on the television 27.

Before the selected video content plays, the server may also send a short advertisement (e.g., 15 seconds to 2 minutes) to play to the consumer before the video content. The advertisement may be targeted based on the video content selected by the consumer 20. The consumer 20 may have access to the paid video content for an extended period (e.g., 24 hours) and have full VCR functionality for viewing the programming (e.g., rewind, pause, fast forward, etc.). The consumer 20 may stay in the portal for as long as desired and then may exit back to the linear network channel to watch the linear programming.

The example described above for the consumer 20 to access the EOD Video Services Platform 10 from the linear network channel may be described as entering the EOD Video Services Platform 10 through the Back Door as described above with reference to FIG. 3. In particular, Back Door access is provided through the linear network channels and transports the consumer 20 to the portal for the corresponding linear network channel that was used to accomplish the Back Door access. The EOD Video Services Platform may also be entered through the Front Door as shown in FIG. 3. Front Door access provides the consumer 20 with direct access to the EOD Video Services Platform 10. This Front Door access may be accomplished by tuning directly to the EOD Video Services Platform channel, e.g., EOD channel 602 (150) of FIG. 4. When a consumer 20 tunes directly to this EOD Video Services Platform channel, the consumer 20 has Front Door access to the EOD Video Services Platform 10. The Front Door access is different from the Back Door access because Front Door access does not require the consumer 20 to pass through a linear network channel.

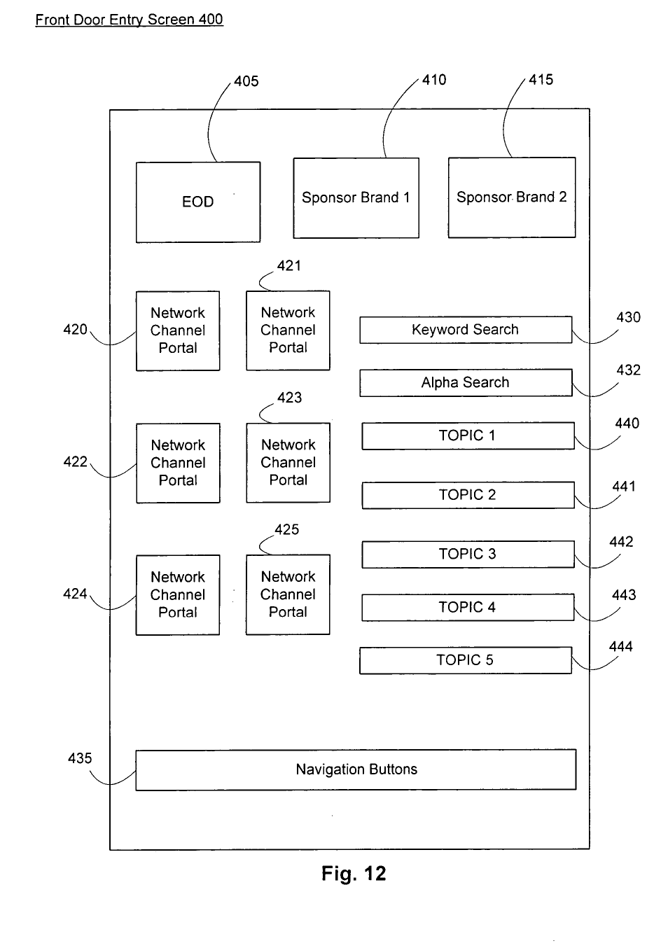

FIG. 12 shows an exemplary Front Door display screen 400 of the EOD Video Services Platform 10. The Front Door display screen 400 includes the EOD Video Services Platform operator logo 405, a first primary sponsor logo 410, a second primary sponsor logo 415 and navigation buttons 435. As described above, the Front Door access is not directly to a linear network channel portal, but rather to a portal that is created by the EOD Video Services Platform 10 operator. The EOD Video Services Platform 10 operator may display their logo to create logo recognition. As with the portal screens described above, there may be primary sponsors for the Front Door display screen 400, e.g., sponsor logo 410 and sponsor logo 415, which the consumer 20 may highlight to obtain current offers or information. One of the sponsors 410 or 420 may be the operator 30 which is co-branding the EOD Video Services Platform 10 with the EOD Video Services Platform operator.

In addition, the screen 400 may display links for network channel portals 420-425 which the consumer 20 may use to enter the individual linear network channel portal. The screen 400 also contains keyword search button 420 and alphabetical search button 422. These buttons work in the same manner as described above for the portals. Finally, the screen 400 includes topic buttons 440-444 which may display general topics for a thematic search. Topics may include, for example, business, entertainment, movies, music, news, shopping, sports, etc.

The content available through the Front Door of the EOD Video Services Platform 10 may include additional content which is not available from the individual network portals. As described above, programmers 40 may make the content they produce or purchase available through their network portals. However, there may be some programmers 40 who do not desire to have an individual network portal, but still desire to make content available through the EOD Video Services Platform 10. In addition, there may be content providers which do not have linear networks (e.g., independent production companies, public access programmers, etc.) that desire to make content available through the EOD Video Services Platform 10. This content may be categorized in the EOD Video Services Platform 10 and made available through the Front Door. The advertisers 50 may have the same access to the consumer 20 as provided in the network portals.

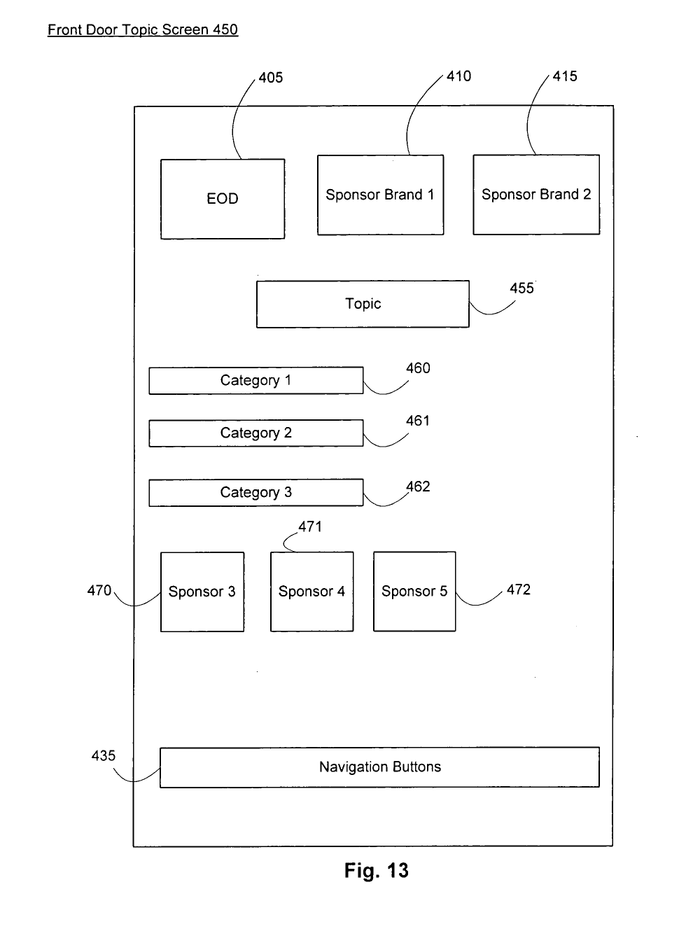

Continuing with the Front Door example, FIG. 13 shows an exemplary Front Door topic screen 450 of the EOD Video Services Platform 10. If a consumer 20 selected one of the topic buttons 440-444 on screen 400, the consumer 20 may then have the screen 450 displayed. As with the portal screens, the branding and sponsorship portions of the screens (e.g., EOD logo 405, first primary sponsor 410 and second primary sponsor 415) generally remain consistent so the consumer 20 understands that they have remained in the same general area of the EOD Video Services Platform 10. The navigation buttons 435 also generally remain the same.

The screen 450 also shows the general topic 455 selected by the consumer 20 with the categories 460-462 available under the topic. For example, if the consumer 20 had selected a Music topic button in screen 400, the screen 450 may display Music in the topic area 455. The categories under music may be Information, Music Videos, Shop, etc. Furthermore, the display screen 450 may include sub-sponsors 470-472 based on the particular topic. For example, sub-sponsors under a Music topic may be a CD retailer, a musical instrument retailer, etc.

A consumer 20 may work their way through the various screens of the Front Door in the same manner as described above for the network portals. The consumer 20 will have the same options to view free content material, purchase content material and make purchases as described above. Thus, the Front Door of the EOD Video Services Platform 10 offers the consumers 20 and the operator 30 the same features and functionality of the network portals.

The EOD Video Services Platform 10 allows for a unique opportunity for the operator 30 to be provided with a turnkey on-demand service which the operator 30 can incorporate into its program offerings. The operator 30 does not need to obtain or categorize the content, advertising or any other of the EOD offerings available via the EOD Video Services Platform 10. The operator 30 merely provides the EOD Video Services Platform 10 with access to the operator's 30 system and a single channel for communication between the EOD Video Services Platform 10 and the consumer 20. Furthermore, the billing of any EOD purchases may be integrated by the operator 30 into the consumer's 20 normal monthly bill. The EOD Video Services Platform 10 provides all the billing information directly to the operator 30 for it to be included in the monthly bills.

Thus, as described above, the EOD Video Services Platform 10 allows for the additional generation of revenue by the selling of additional sponsorships inside the portals and the Front Door and by the increased revenue associated with providing a full library of content not previously available and catalogued for consumers 20. This revenue may be split up in any number of ways between the operator 30, the programmer 40 and the EOD Video Services Platform 10 operator. For example, in exchange for providing the editing services to create the short form preview material, the EOD Video Services Platform 10 operator may collect the revenue associated with the 15-30 second ads which run before or after the short form content. Those of skill in the art will understand that this description included multiple revenue streams and these revenue streams may be divided among the various entities (EOD Video Services Platform 10 operator, operator 30 and programmer 40) in any number of manners which is to the advantage of all.

The preceding description of the EOD Video Services Platform 10 and the examples provided herein describe the unique combination of components and services provided by the EOD Video Services Platform 10. Referring back to FIG. 1, a summary of the novel relationships between the EOD Video Services Platform 10 and the constituents 20-50 will be provided. This summary is not intended to be a complete list of these relationships, but rather some exemplary characteristics and benefits of the relationship between the EOD Video Services Platform 10 and the constituents 20-50. The programmers 40 will provide source programming to be made available within the EOD Video Services Platform 10 and co-branding of the customized portals for the networks within the EOD Video Services Platform 10.

The EOD Video Services Platform 10 will create new programming assets for the programmer 40, manages the programming assets of the programmer 40, provides new sources of revenue for the programmer 40 and enhances the value of the linear networks by providing the on-demand functionality that is perceived by the consumer to be an extension of the linear network. The new programming assets may be, for example, the short form content or the on-demand content created by the editorial services of the EOD Video Services Platform 10. The EOD Video Services Platform 10 manages the programming assets by organizing, cataloging and storing the programs. Thus, the programmer 40 merely needs to make content available to the EOD Video Services Platform 10 and the remaining responsibilities of managing the content will shift to the EOD Video Services Platform 10. The programmer 40 may make its entire catalogue of content available on-demand to consumers 20 without any additional effort than merely sending a single copy of the content to the EOD Video Services Platform 10. Thus, making the entire library of content of a programmer 40 available on-demand for a payment to consumers 20 affords the programmer 40 a source of revenue which it does not currently have available. Other revenue streams may result from advertising revenue from the co-branding of the customized portal.

The advertisers 50 pay for the advertisement insertion and banner ads within the EOD Video Services Platform 10. The advertisers 50 also pay for category sponsorships and for placement based on search results. The EOD Video Services Platform 10 delivers audiences with a high propensity to respond to the ad messages and correlated to hyper-targeted demographics. In addition, the EOD Video Services Platform provides precise consumer 20 data to the advertisers 50 in order that they may refine the advertisement targeting. For example, the EOD Video Services Platform 10 may record statistics on viewing habits with respect to individual consumers 20, individual shows, individual networks, etc. This data may be made available to the advertisers 50 to allow for a more focused advertising message.

The operators 30-provide the EOD Video Services Platform 10 with access to their distribution system and may provide on and off-air promotion of the services provided by the EOD Video Services Platform 10. The EOD Video Services Platform 10 provides the operator 30 with a turnkey on-demand platform which provides numerous advantages and features not currently provided by VOD services currently deployed. The EOD Video Services Platform 10 offers the operator 30 the ability to stage the deployment of the EOD Video Services Platform 10 because, as described above, the components of the EOD Video Services Platform 10 are modular. In addition, the EOD Video Services Platform 10 is a turnkey system which can be deployed in a system 35 of an operator 30 with minimal customization, configuration and very little intervention by the operator 30. The EOD Video Services Platform 10 creates a more robust and attractive content offering which supports the operator's 30 goal of attracting new subscribers and retaining current subscribers.

The billing and subscriber maintenance interface provided by the EOD Video Services Platforms 10 allows for the EOD Video Services Platform 10 to maintain billing information for individual consumers 20. For example, the EOD Video Services Platform will record each pay transaction by an individual consumer and the content for which the consumer 20 has ordered. This information may be captured because, as described above, the EOD Video Services Platform 10 will deliver the requested content to the set top box 23 of the individual consumer 20. Thus, the EOD Video Services Platform 10 will know the address of the set top box 23 to which content was delivered. The EOD Video Services Platform 10 may dynamically monitor the activities of the consumer over time through the set top box address and subscriber account number. Thus, for each pay transaction, the EOD Video Services Platform 10 may record the amount owed by the consumer 20. In addition, the EOD Video Services Platform 10 may record the content for this pay transaction.

At regular intervals (e.g., monthly), the EOD Video Services Platform 10 may transfer this information to the operator 30 so that the information may be included in the monthly bill provided by the operator 30. The information incorporated into the bill may include a listing of the individual charges and content for the consumer 20 to review and pay. The operator 30, when deploying the EOD Video Services Platform 10, does not need to implement a separate billing system or arrangement, but merely needs to accept information on a regular basis from the EOD Video Services Platform 10 to be incorporated into the normal bills sent to consumers 20. Because the billing is part of the turnkey system, the operator 30 is alleviated from maintaining this extra billing information and the consumer 20 receives a single bill for all the services provided by the operator 30.

In addition, the EOD Video Services Platform 10 may also maintain the billing information for transactions between the programmer 40 and the operator 30. For example, if the programmer 40 is to receive a percentage of the amount paid for each of its content material viewed on-demand, the EOD Video Services Platform 10 may indicate to the operator 30 the amount owed to the programmer with each report. Those of skill in the art will understand that there may be many arrangements between the operator 30 and the programmer 40 for sharing revenue, but the EOD Video Services Platform 10 may record the information for any such arrangement.

Continuing with the exemplary relationships, the consumers 20 provide the EOD Video Services Platform 10 with viewers for the advertising content and also pay for subscription and transactional fees. The EOD Video Services Platform 10 provides an upgraded on-demand service complete with easy-to-use navigational and search tools. In addition, the EOD Video Services Platform 10 provides targeted advertising content for the individual consumer 20 and e-commerce referrals for desired products and services.

The preceding examples included descriptions related to CATV operators where applications resided on set top boxes connected to a CATV operator system. However, as described above, the operators may also be broadband operators, satellite operators, etc. The functions, features and service provided by the EOD Video Services Platform via these other operators remain the same as described above. The principles of delivering the EOD Video Services Platform may vary slightly based on the individual operator. For example, as currently deployed, satellite services do not include VOD services because there is no ability for the consumer to have a real time return path to the satellite operator. Therefore, deployment of the EOD Video Services Platform for a satellite service may depend on finding an alternate return path to the satellite provider (e.g., telephone network, land-line Internet, etc.) or deployment may be as described above when satellite services provide the return path through the satellite tuner. Thus, while the above description focused on a CATV deployment, the EOD Video Services Platform may be deployed by any number of system opoerators.

In the preceding specification, the present invention has been described with reference to specific exemplary embodiments thereof. It will, however, be evident that various modifications and changes may be made thereunto without departing from the broadest spirit and scope of the present invention as set forth in the claims that follow. The specification and drawings are accordingly to be regarded in an illustrative rather than restrictive sense.

1. A method, comprising the steps of:
storing a full-length video program;
storing a short form program, wherein the short form program is an edited version of the full-length video program;
storing searchable parameters for the full-length video program and the short form program;
receiving a search request from a user, the search request including search parameters; and
returning search results to the user including the full-length video program and the short form program when the search parameters match the searchable parameters of the full-length video program and the short form program.

2. The method according to claim 1, further comprising the steps of:
formatting and displaying the search results to the user.

3. The method according to claim 1, further comprising the steps of:
providing on-demand, based on a selection by the user, the full-length video program for a fee.

4. The method according to claim 1, further comprising the steps of:
storing advertising content; and
providing on-demand, based on a selection by the user, the short form program at no cost, wherein the short form program is provided with advertising content.

5. The method according to claim 4, wherein the advertising content provided with the short form program is based on one of the search parameters and the searchable parameters.

6. The method according to claim 1, further comprising the step of:
receiving the full-length video program from a programmer.

7. The method according to claim 1, further comprising the step of:
editing the full-length video program to create the short form program.

8. A system, comprising:
a receiving module configured to receive full-length video programming content from a programmer;
an editorial module configured to edit the full-length video programming content into short form content;
a storage module configured to store the full-length video content and the short form content;
a categorization module configured to store information on the full-length video content and short form content;
a search module configured to receive search parameters from a user and search the stored information; and
a display module configured to send search results to the users based on the search parameters.

9. The system according to claim 8, further comprising:
a fulfillment module configured to provide on-demand, based on a selection by the user, the full-length video content for a fee and the short form content at no cost, wherein the short form content is provided with advertising content.

10. The system according to claim 9, wherein the fee for the full-length video content is distributed to one of an operator of the system, the programmer and a distribution system operator.

11. The system according to claim 10, wherein the distribution system operator is one of a cable television operator, a satellite television service and an internet service provider.

12. The system according to claim 8, wherein the stored information for the full-length video content includes one of a title, a topic, a sub-topic and a category.

13. The system according to claim 8, wherein the receiving module is further configured to receive content from third party data feeds.

14. The system according to claim 13, wherein the content received from third party data feeds includes advertising content from advertisers.

15. A platform system, comprising:
an aggregation module to collect a plurality of full-length video programs from programmers;
an editorial module to edit the full-length video programs to meet requirements to distribute the full-length video programs on-demand and to edit the full-length video programs to create independent short form programs corresponding to the full-length video programs;
an advertising module to receive advertising content from advertisers, wherein the advertisers pay a fee to include the advertising content in the platform system; and
a consumer module to provide consumer services to users of the platform.

16. The platform according to claim 15, wherein the advertising content includes one of banner ads and hyperlinks.

17. The platform according to claim 15, wherein the advertising content is video content which is inserted into a video stream which includes one of the short form programs.

18. The platform according to claim 15, wherein the fee paid by the advertisers is distributed to one of an operator of the platform system, the programmer and a cable system operator.

19. The platform according to claim 15, wherein the aggregation module categorizes and manages the full-length video programs.

20. The platform according to claim 15, wherein the consumer services include one of personalized user interfaces, search functions, navigation functions and commerce referrals.

21. A method, comprising the steps of:
providing on-demand full-length video programming content to a user based on one of a first revenue model and a second revenue model; and
providing on-demand short form programming content to the user based on one of the first revenue model and the second revenue model, the short form content being an edited version of the full-length video programming content, wherein the short form content is provided with advertising content.

22. The method of claim 21, wherein one of the first revenue model and the second revenue model is a pay for use revenue model.

23. The method of claim 21, wherein one of the first revenue model and the second revenue model is an advertiser supported revenue model.

24. The method of claim 21, wherein one of the first revenue model and the second revenue model is a subscription based revenue model.

25. A method, comprising the steps of:
providing a linear channel network to a consumer, the linear network channel being video-on-demand portal enabled;
providing an video-on-demand portal to the consumer, the consumer accessing the video-on-demand portal by one of directly accessing the video-on-demand portal and accessing the video-on-demand portal via the linear channel network, wherein, when the video-on-demand portal is accessed via the linear channel network, the consumer is displayed a branded video-on-demand portal related to the linear channel network; and
providing video-on-demand portal applications to the consumer, wherein the video-on-demand portal applications include one of a search portal application, a purchase content application, a access free content application and an access commercial content application;

26. The method according to claim 25, wherein the linear network channel is a digital television network.

27. The method according to claim 25, wherein the linear channel network and the video-on-demand portal is provided via a set top box.

28. The method according to claim 25, wherein the linear network channel is provided on a first television channel and the video-on-demand portal is provided on a second television channel.

29. The method according to claim 28, wherein multiple branded video-on-demand portals are provided on the second television channel.

30. The method according to 25, wherein the branded video-on-demand portal includes content from the linear network channel and the portal applications allow the consumer to search the content of the branded video-on-demand portal.

31. The method according to 25, wherein the-branded video-on-demand portal includes an entry screen displaying the logo of the linear network channel.

32. The method according to claim 31, wherein the entry screen further displays a primary sponsor logo.

33. The method according to claim 31, wherein the entry'screen further displays one of an alphabetical search button, a keyword search button, a topical search button and ancillary content.

34. The method according to claim 31, wherein the branded video-on-demand portal further includes one of search result screen, a sponsor referral screen, a category screen, a topic screen and a sub-topic screen.

35. The method according to claim 25, wherein the video-on-demand portal is configurable by the consumer.

36. The method according to claim 25, wherein, when the video-on-demand portal is directly accessed, the consumer is displayed an video-on-demand portal entry screen.

37. A system, comprising:
a server including stored video content, categorization information for the stored video content and video-on-demand portal information;
a set top box configured to tune to a linear network channel and further configured to tune to an video-on-demand portal channel, the video-on-demand portal channel including access to a main video-on-demand portal and a customized portal corresponding to the linear network channel, wherein the set top box tunes from the linear network channel to the video-on-demand portal channel and receives a portion of the video-on-demand portal information to display the customized portal on a display screen connected to the set top box, the customized portal display including information for the consumer to search the stored video content based on the categorization information and purchase the stored video content.
